(19) United States
(12) Patent Application Publication
(10) Pub. No.: US 2016/0161061 A1
(43) Pub. Date: Jun. 9, 2016

(54) Safety Device for a Pressurized Gas Tank, in Particular of a Motor Vehicle

(71) Applicant: Bayerische Motoren Werke Aktiengesellschaft, Muenchen (DE)

(72) Inventor: Jan-Mark KUNBERGER, Muenchen (DE)

(21) Appl. No.: 15/019,999

(22) Filed: Feb. 10, 2016

Related U.S. Application Data
(63) Continuation of application No. PCT/EP2014/070762, filed on Sep. 29, 2014.

(30) Foreign Application Priority Data
Oct. 9, 2013 (DE) 10 2013 220 388.8

(51) Int. Cl. F17C 13/04; F16K 31/02

(52) U.S. Cl. CPC F17C 13/04; F16K 31/025; F17C 2205/0332; F17C 2250/03; F17C 2250/0439; F17C 2260/023; F17C 2270/0168

(57) ABSTRACT

A safety device is provided for a pressurized gas tank in particular of a motor vehicle. The safety device has a thermoelectric device provided on a larger surface area of the tank, which thermoelectric device makes electrical energy available under the effect of heat. The safety device, in a suitable design of the system, controls either directly or indirectly a pressure-relief device of the tank in order to avoid heat-related damage to the tank. The thermoelectric device is formed by a plurality of interconnected thermoelectric generators, the electrical energy of which produced by the effect of heat is supplied to at least one capacitor. The two electrodes of the capacitor are connected to each other via a discharge resistor. The system is designed such that a defined power differential between the power produced by the thermoelectric generators and the power dissipated by the discharge resistor results in the control of the pressure relief device either directly or indirectly via a relay circuit.

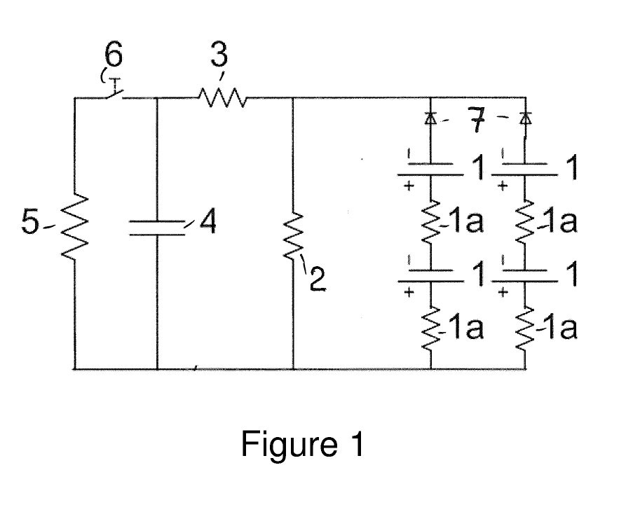

### CROSS REFERENCE TO RELATED APPLICATIONS

This application is a continuation of PCT International Application No. PCT/EP2014/070762, filed Sep. 29, 2014, which claims priority under 35 U.S.C. §119 from German Patent Application No. 10 2013 220 388.8, filed Oct. 9, 2015, the entire disclosures of which are herein expressly incorporated by reference.

### BACKGROUND AND SUMMARY OF THE INVENTION

The invention relates to a safety device for a pressurized gas tank, in particular of a motor vehicle. The safety device has a thermoelectric device provided on a larger surface area of the tank which, in response to the effect of heat, makes electrical energy available. The safety device, in an appropriate design of the system, controls either directly or indirectly a pressure-relief device of the tank in order to avoid heat-related damage to the tank.

A safety device of this type is described in DE 10 2007 022 610 B4 which, in accordance with the known prior art, discloses a “thermal battery” with electrolytes which, under normal ambient conditions, are frozen and consequently non-ion-conducting. In the event of the production of higher heat energy, for example in the case of a fire or a rise in temperature on any other grounds, in the immediate vicinity of the tank, the latter is warmed and thus, on account of an appropriate design of the system, the thermoelectric battery is warmed to such an extent that it delivers a sufficient quantity of electric current to actuate the opening of a pressure relief valve on the tank, when the maximum safe operating temperature of the tank and the heat transferred at this temperature is exceeded. In consequence thereof, the pressurized gas stored in the tank is released from the latter. The pressure in the tank space is therefore relieved before the generation of heat in the vicinity thereof can cause significant damage to the structure of the tank. The tank is comprehensively protected against intensive heat sources, in that the thermal battery covers a significant proportion of the tank surface.

The requisite system design for the successful operation of this known safety device would be extremely difficult to identify; moreover, it is difficult to envisage, at present, how a thermal battery of this type, in particular for use in a motor vehicle, might cover a larger surface area of the tank at an acceptable structural cost. Accordingly, a correspondingly improved safety device is disclosed herein.

The improved safety device is characterized in that the thermoelectric device is formed by a plurality of interconnected thermoelectric generators, the electrical energy of which, generated by the effect of heat, is supplied to an electric and/or electronic storage unit. Both poles or electrodes of the storage unit are mutually connected via a discharge resistor, whereby the design of the system is such that a specified power differential between the power produced by the thermoelectric generators and the power dissipated in the discharge resistor actuates the pressure-relief device, either directly or indirectly, via an electrical or electronic control circuit.

According to advantageous further developments of the invention, the electric and/or electronic storage unit may include at least one capacitor and/or, depending upon the electrical potential present in the storage unit, a closing switch may be provided in an electric circuit which supplies the electrical energy stored in the storage unit to an electrically-actuated pressure-relief device.

The thermal battery described above is replaced by a plurality of thermoelectric generators, which are characterized by their known—and inherent—compact construction, and are consequently easily distributable or distributed over the surface of the tank in sufficient numbers such that not only a small surface area of the tank, but rather a larger surface area of the tank is covered. This ensures that even a high “point-type” heat source or the intensive action of heat on only a small surface area of the external wall of the tank will be reliably recorded by the safety device, whereby at least one or more of the thermoelectric generators will generate or deliver a significant quantity of electrical energy in response to the incidence of heat.

Furthermore, a storage unit is provided for electrical energy, for example in the form of an electrical capacitor circuit, i.e. comprising a capacitor or a plurality of appropriately interconnected capacitors, which is connected to the appropriately interconnected thermoelectric generators (i.e. in parallel and/or in series), such that the electrical energy generated in the thermoelectric generators in response to heat is fed to the electrically- or electronically-configured storage unit(s). This storage unit, or the capacitor(s), provide an intermediate storage facility for the electric power generated by the thermoelectric generators, which accumulates therein accordingly such that, as a key aspect of the present invention, the time interval over which a relevant incidence of heat to the tank occurs is or may be taken into consideration. Naturally, however, this accumulation of electric power generated in the thermoelectric generators must not be unlimited over time, but must be restricted to a given time interval, in consequence whereof, according to the invention, the two poles or the opposing-pole electrodes of the storage unit (or capacitors) are interconnected via a discharge resistor, such that a given discharge of the storage unit (or of the capacitor(s)) also proceeds continuously. The entire system, i.e. the thermoelectric generators and the storage unit, together with the discharge resistor, considered as a whole, is designed such that a specific positive power differential between the power generated by the thermoelectric generators and the power dissipated in the discharge resistor, either directly or indirectly via an electric/electronic circuit (described as a circuit arrangement and configured as a relay circuit, but which may also be configured using transistors or similar), actuates the pressure-relief device. In the event of a significant incidence of heat on at least a number of the thermoelectric generators, this positive power differential (i.e. where the power generated exceeds the power dissipated in the discharge resistor) is initially stored in the storage unit (or capacitors), such that the electrical potential between the electric poles (or the opposing pole capacitor electrodes) increases. If a specific voltage value dictated by the system design is achieved, this results in an appropriate actuation of a pressure-relief device of the tank, by which at least part of the pressurized gas stored therein is released from the tank.

To this end, the pressure-relief device may be electrically-actuated, wherein the requisite energy, not only for the actuation thereof but also for the opening of the pressure-relief device, is sourced directly from the electrical energy stored in the storage unit. Alternatively, an appropriate electric or electronic circuit arrangement may be provided which, upon the achievement of a specific voltage value between the electric poles of the storage unit, appropriately actuates the pressure-relief device, which may be configured for example in the form of an ignition capsule (an electrically-actuated detonator).

Preferably, organic thermoelectric generators may be used (c.f. for example DE 10 2007 022 610 B4 or the following web link: http:pro-physik.de/details/news/1429801/Strom_aus_Kunststoff.html). Such generators are elastic and consequently moldable and adaptable to curved surfaces, and are advantageously unsusceptible to vibrations and impacts. Moreover, the geometry thereof is substantially unrestricted, such that virtually optimum adjustment to the desired thermal system resistance can be achieved. Currently known organic thermoelectric generators are sufficiently temperature-stable for the application proposed herein, and may be connected in series or in parallel as required, thereby permitting the internal resistance and the output voltage of the desired system design to be adjusted accordingly.

Moreover, a safety device according to the invention, specifically where a combustible gas is stored in the pressurized gas tank, may be provided with an electric ignition device for the gas released from the pressurized gas tank by the actuation of the pressure-relief device in the event of a hazard situation, whereby the ignition energy for the ignition device is sourced from the above-mentioned electric and/or electronic storage unit.

Other objects, advantages and novel features of the present invention will become apparent from the following detailed description of one or more preferred embodiments when considered in conjunction with the accompanying drawing.

### BRIEF DESCRIPTION OF THE DRAWING

The single FIGURE is a highly schematic electrical circuit diagram in accordance with an exemplary embodiment of the present invention.

### DETAILED DESCRIPTION OF THE DRAWING

The single FIGURE attached shows, in a substantially simplified form, an electric circuit with a plurality of thermoelectric generators 1, interconnected in the present case with their system resistors 1a, partly in parallel and partly in series, and connected overall, with the interposition of diodes 7 via a precharging resistor 3, to an electric and/or electronic energy storage unit 4. The storage unit 4 is configured here in the form of a capacitor circuit 4 comprising at least one electric capacitor. The opposing-pole electrodes of the capacitor circuit 4 or of the single capacitor 4, represented here in diagrammatic form, are interconnected via a discharge resistor 2. An, in this case, electrically-actuated pressure-relief device 5 a pressurized gas tank (not shown) of a motor vehicle and a circuit incorporating a voltage-dependent closing switch 6 are also connected to the capacitor circuit 4 (or to the electric poles of the electric energy storage unit 4).

The thermoelectric generators 1 are distributed over the surface of the pressurized gas tank to be monitored, and are preferably fitted directly to the surface. In the event of an increased temperature on this tank surface, an electric voltage is generated in the thermally-loaded thermoelectric generators 1, which is fed via the diodes 7 and the precharging resistor 3 to the capacitor 4 (or the capacitor circuit 4 or the other storage device). As long as there is no significant incidence of heat, or in the event of only a very small incidence of heat on the thermoelectric generators 1 and, accordingly, the capacitor 4 is only charged to a very limited extent, the capacitor 4 will be continuously maintained in the discharged state via the precharging resistor 3 and the discharge resistor 2. However, in the case of a so-called “thermal event”, i.e. if the pressurized gas tank, and consequently the thermal generators 1 are exposed to a more significant incidence of heat, the electric power generated in the thermal generators 1 may continuously exceed the power dissipated by the discharge resistor 2 and, over a given period of time, the capacitor 4 will be charged up to a limiting voltage. Upon the achievement of this limiting voltage, the initially open switch 6, which may be configured, e.g., in the form of a logic component, is closed, and the electrical energy stored in the capacitor 4 is then employed for the actuation of the pressure-relief device 5.

Accordingly, using the safety device disclosed herein, the impact of a high temperature upon a pressurized gas tank over a critical time period can be simply and reliably determined, and the entire surface of the pressurized gas tank can be monitored, in the manner of a skin. Advantageously, the safety device operates independently, i.e. without the use of an external energy source and, upon the detection of a time-critical incidence of heat in a vehicle in which the pressurized gas tank is installed, the independent release of pressure in the pressurized gas tank will ensue. Accordingly, uninterrupted monitoring of the tank surface is possible, and the requisite electrical energy is independently generated from the unwanted incidence of heat, generally resulting from a fire. Moreover, the additionally proposed organic thermoelectric generators may be easily manufactured using 3D printing technology, and the safety device may also be used for monitoring of the critical temperature during the filling of the pressurized gas tank.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A safety device for a pressurized gas tank, said safety device having a thermoelectric device provided on a large surface area of the tank which, in response to effect of heat, makes electrical energy available, wherein:
the safety device, in a specified design of a system, controls either directly or indirectly a pressure-relief device of the tank, in order to avoid heat-related damage to said tank,
the thermoelectric device is formed by a plurality of interconnected thermoelectric generators, the electrical energy of which, generated by the effect of heat, is supplied to an electric and/or electronic storage unit,
both poles or electrodes of the storage unit are mutually connected via a discharge resistor, and
the design of the system is such that a specified power differential between power produced by the thermoelectric generators and power dissipated in the discharge resistor actuates the pressure-relief device, either directly or indirectly via an electrical or electronic control circuit.

2. The safety device according to claim 1, wherein the electric and/or electronic storage unit comprises at least one capacitor.

3. The safety device according to claim 2, further comprising:
a closing switch in an electric circuit which supplies the electrical energy stored in said storage unit to an electrically-actuated pressure-relief device depending upon electrical potential present in the electric and/or electronic storage unit.

4. The safety device according to claim 1, wherein the thermoelectric generators are organic thermoelectric generators.

5. The safety device according to claim 1, further comprising:
an electric ignition device for gas released from the pressurized gas tank via the pressure-relief device, wherein ignition energy is sourced from the electric and/or electronic storage unit.

6. The safety device according to claim 1, wherein the safety device is for a motor vehicle pressurized gas tank.

7. A safety device for a pressurized gas tank equipped with a pressure relief device, the safety device comprising:
a plurality of interconnected thermoelectric generators arranged on a surface area of the pressurized gas tank;
an electrical energy storage unit;
a discharge resistor mutually coupling both poles or electrodes of the electrical storage unit, wherein
electrical energy generated by the plurality of interconnected thermoelectric generators in response to heat is supplied to the electrical storage unit, and
a defined power differential between power produced by the plurality of interconnected thermoelectric generators and power dissipated in the discharge resistor operates to actuate the pressure relief device of the pressurized gas tank in order to avoid heat-related damage to the pressurized gas tank.

8. The safety device according to claim 7, wherein the actuating of the pressure relief device is carried out directly or indirectly via a control circuit.

9. The safety device according to claim 7, wherein the electrical storage unit comprises a capacitor.

10. The safety device according to claim 7, further comprising:
a closing switch arranged in an electric circuit that supplies electrical energy stored in the electrical storage unit to the pressure-relief device configured to be electrically actuated.

11. The safety device according to claim 7, wherein the plurality of interconnected thermoelectric generators are organic thermoelectric generators.
